(19) United States
(12) Patent Application Publication
(10) Pub. No.: US 2006/0133064 A1
(43) Pub. Date: Jun. 22, 2006

(54) Mini dynamic light

(76) Inventor: Ming-Kuei Lin, Taipei Hsien (TW)

Correspondence Address: DAVID E. DOUGHERTY;Dennison, Schultz, Dougherty & Macdonald, Suite 105, 1727 King Street, Alexandria, VA, 22314-2700, US

(21) Appl. No.: 11/014,829

(22) Filed: Dec. 20, 2004

(51) Int. Cl. F21V 33/00

(52) U.S. Cl. 362/101; 362/96

(57) ABSTRACT

A mini dynamic light includes a light set and a USB connector. The light set consists of a base, a transparent container and a cover. A four or five watt light bulb is installed on the base. The USB connector extends outward from the base while the transparent container is disposed on top of the base. A low-boiling-point clear liquid with a plurality of differently colored lustrous foil fragments therein is filled inside the transparent container. In usage, the USB connector is connected to a computer hub for getting power supply so as to make the light bulb illuminate and heat the transparent container. Thus the liquid therein generates convention currents to drive the lustrous foil fragments. The glittery and dynamic visual effect is achieved.

### BACKGROUND OF THE INVENTION

The present invention relates to a mini dynamic light, especially a light that is connected with a hub of computers by a USB connector. By the power supply from the hub, a light bulb illuminates and heats a transparent container. And liquid inside the transparent container is heated and circulated to form convection currents and a plurality of differently colored lustrous foil fragments flowing inside the liquid is driven by convective force. Thus a colorful and dynamic visual effect is achieved.

There are various designs of lights for illumination or decoration on desks. However, most of such kind of lights are static and is connected to an indoor power supply. A prior art is disclosed in U.S. Pat. No. 6,309,084 B1 ┌LAMP SHOWING DYNAMICALLY CHANGEFUL LUSTER AND SHADOW┘ applied by the same inventor of the present invention, a conventional lamp showing floating and lustrous foil fragments is shown in FIG. 1. The conventional lamp with floating and lustrous foil fragments has bigger volume, includes a high-watt light bulb as a heat source, and using indoors power sources. Most of the conventional lamps are disposed in a certain place with larger space inside the house. Thus they are not suitable to put on desks, near the computer inside the office. Neither do they use the 5-volt power source from the hub of computers, or installed inside cars with power source from 12-volt battery. The sites for being applied are limited.

### SUMMARY OF THE INVENTION

Therefore it is a primary object of the present invention to provide a mini dynamic light composed by a light set and a USB connector. The light set consists of a base and a transparent container. A four or five watt light bulb is installed on the base. The USB connector extends outward from the base while the transparent container is disposed on top of the base. A low-boiling-point clear liquid with a plurality of differently colored lustrous foil fragments therein is filled inside the transparent container. By the connection between the USB and a computer hub, the light bulb gets 5-volt power supply via the hub for illuminating and heating the transparent container so that the liquid therein generates convention currents to drive the lustrous foil fragments. The glittery and dynamic visual effect is achieved.

It is another object of the present invention to provide a mini dynamic light composed by a light set and a cigarette lighter plug. The light set consists of a base and a transparent container. A four or five watt light bulb is installed on the base. A cigarette lighter plug extends outward from the base while the transparent container is disposed on top of the base. A low-boiling-point clear liquid with a plurality of differently colored lustrous foil fragments therein is filled inside the transparent container. By power supply from car battery, the light bulb illuminates and heats the transparent container so that the liquid therein generates convention currents to drive the lustrous foil fragments. Thus the glittery and dynamic visual effect is achieved.

### BRIEF DESCRIPTION OF THE DRAWINGS

The structure and the technical means adopted by the present invention to achieve the above and other objects can be best understood by referring to the following detailed description of the preferred embodiments and the accompanying drawings, wherein

FIG. 1 is a perspective view of an embodiment in accordance with the present invention;

FIG. 2 is an explosive view of the embodiment shown in FIG. 1;

FIG. 3 is an embodiment of the present invention being used;

FIG. 4 is a schematic drawing of the embodiment of the present invention being used in another way;

FIG. 5 is a perspective view of another embodiment in accordance with the present invention;

FIG. 6 is a perspective view of a further embodiment in accordance with the present invention.

### DETAILED DESCRIPTION OF THE PREFFERED EMBODIMENT

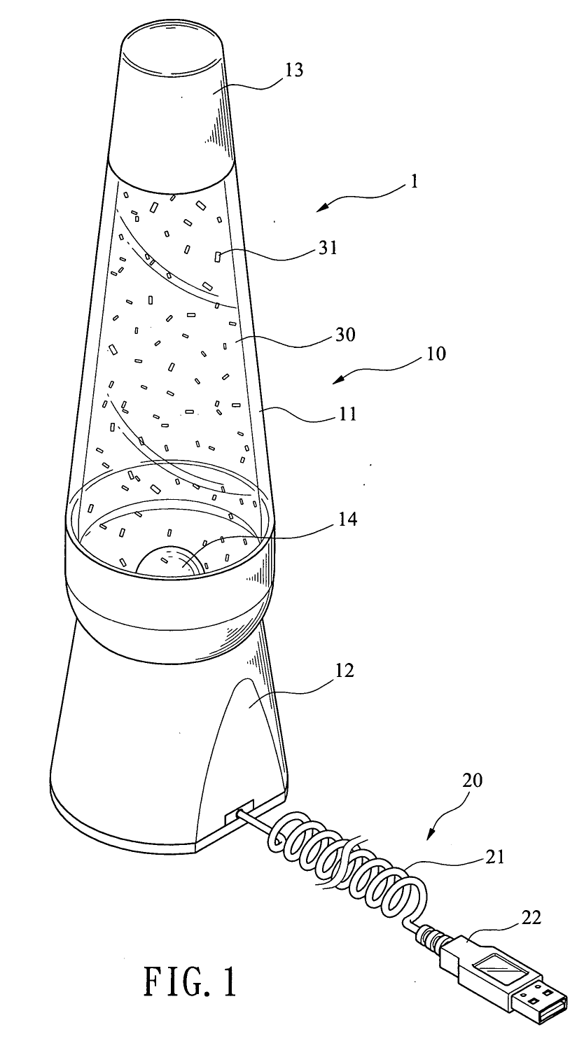

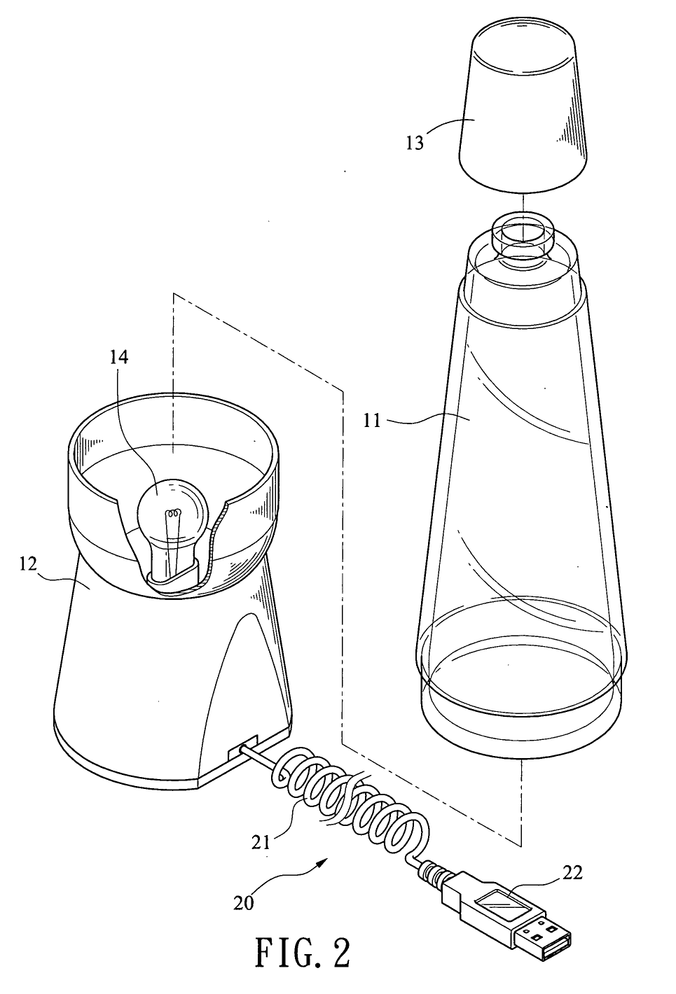

Refer to FIG. 1 & FIG. 2, a mini dynamic light 1 in accordance with the present invention is composed by a light set 10 and a USB (Universal Serial Bus) connector 20. The light set 10 includes of a transparent container 11, a base 12, and a cover 13. The transparent container 11 made of glass or heat-resistant plastic is disposed on top of the base 12 with smaller volume than conventional lamps with lustrous foil fragments. A cap is sealed on top of the transparent container 11 and the cover 13 is coated on the cap for protection and decoration. A low-boiling-point clear liquid 30 with a plurality of differently colored lustrous foil fragments 31 therein is filled inside the transparent container 11. A circuitry (not shown in figure) and a four or five watt light bulb 14 are arranged inside the base 12. The light bulb 14 is close to the bottom side of the transparent container 11 and illuminates upwards. The USB connector 20 having a wire 21 and a USB plug 22 extends outwards from the base 12.

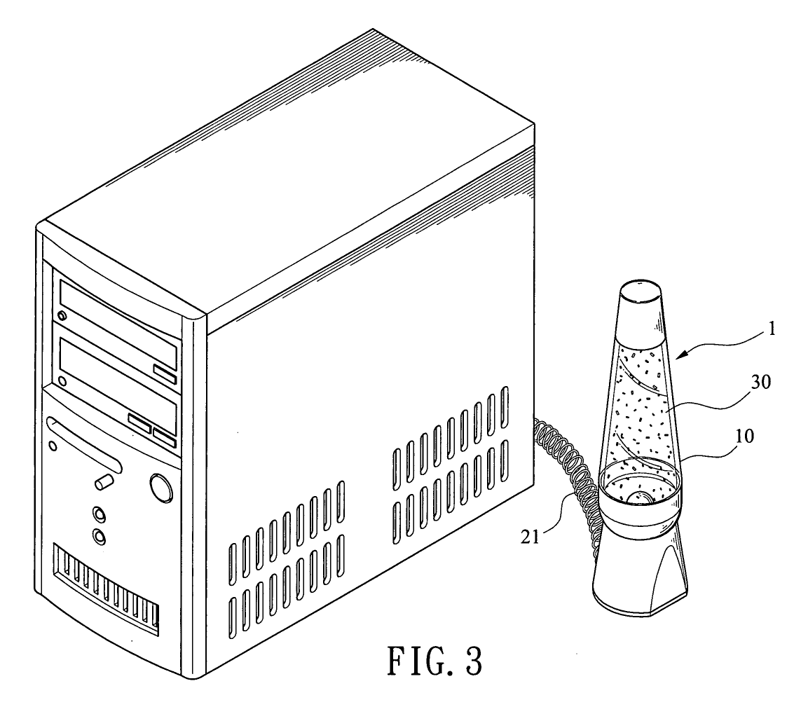

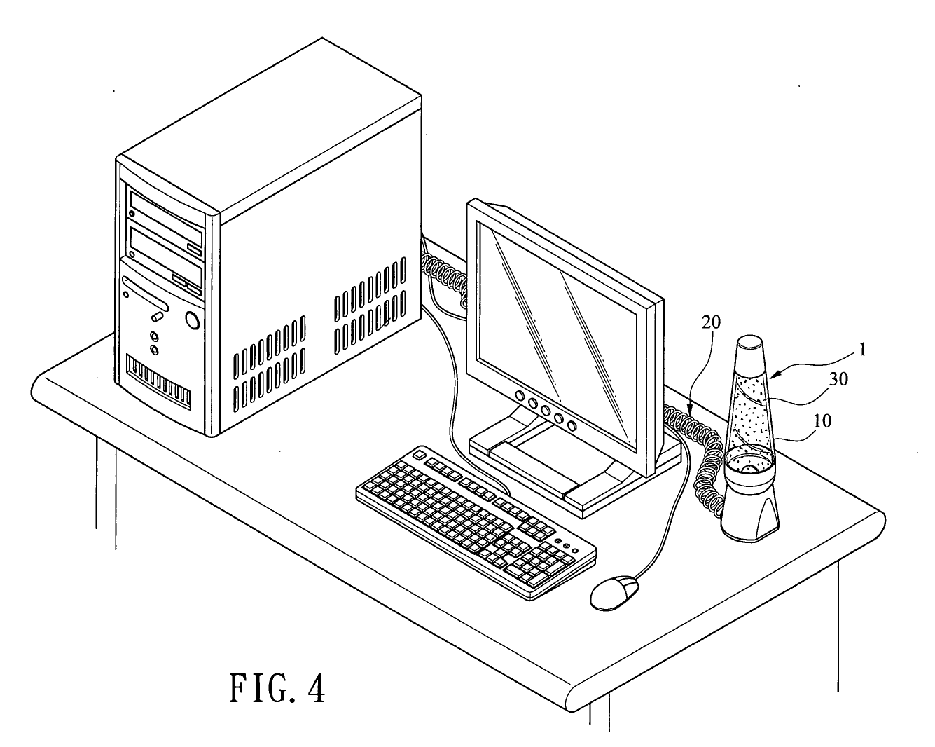

Refer to FIG. 3 & FIG. 4, the USB plug 22 of the USB connector 20 is connected to the computer hub. By the five-volt power source from the computer hub, the four or five watt light bulb 14 illuminates and generates heat. Due to the small volume of the transparent container 11, the liquid 30 inside the transparent container 11 is heated by the light bulb 14 thus generating convection currents so as to drive the differently colored lustrous foil fragments 31 flowing. By the illumination and reflection of the light bulb 14, a colored and dynamic effect is achieved.

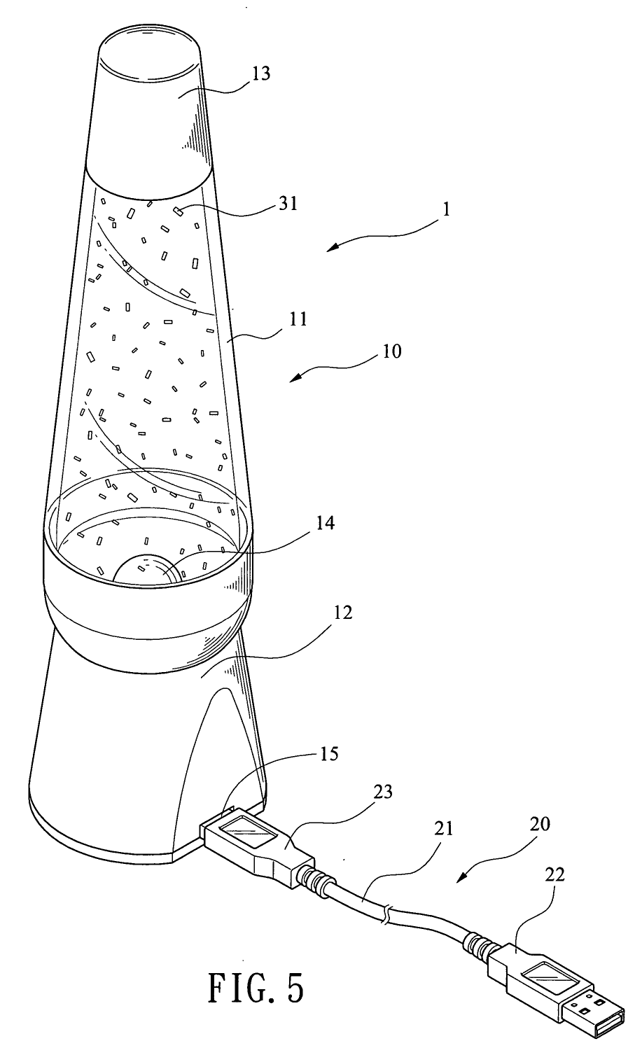

Refer to FIG. 5, a USB connector 20 extends outwards from the base 12. The USB connector 20 is connected with the base 12 by a USB socket 15. The USB connector 20 having a wire 21 with two USB plugs 22, 23 on two ends respectively. The USB connector 20 can be separated with the base 12. When being used, one USB plug 23 of the USB connector 20 is connected with the USB socket 15.

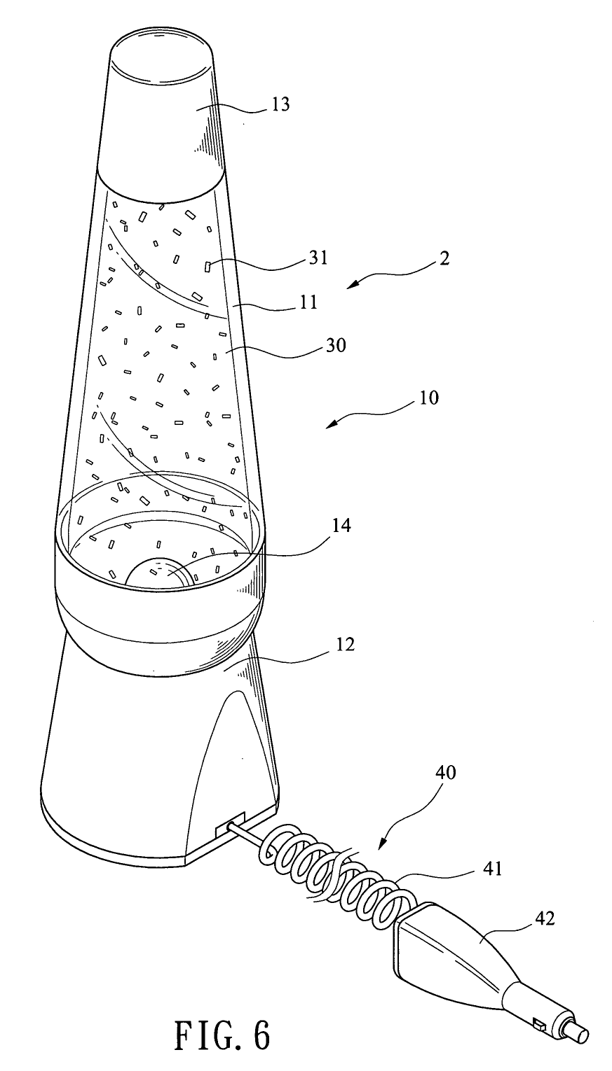

Refer to FIG. 6, another embodiment of the present invention is disclosed. A mini dynamic light 2 includes a light set 10 and a cigarette lighter plug set 40. The light set 10 is the same with the light set 10 of above embodiment 1. The cigarette lighter plug set 40 extending outwards from the base 12 consists of a wire 41 and a cigarette lighter plug 42. In usage, the cigarette lighter plug 42 is connected with a cigarette lighter socket. By 12-volt power supply from car battery, the light bulb 14 illuminates and heats the transparent container 11 so that the liquid 30 therein generates convention currents to drive the lustrous foil fragments 31. Thus the glittery and dynamic visual effect is achieved.

What is claimed is:

1. A mini dynamic light comprising a light set and a USB connector, wherein the light including a transparent container, a base, and a cover; the transparent container made of glass or heat-resistant plastic is disposed on top of the base with a low-boiling-point clear liquid as well as a plurality of differently colored lustrous foil fragments therein; a circuitry and a four or five watt light bulb are installed inside the base while the light bulb is close to bottom side of the transparent container for illuminating upwards;
the USB connector having a wire and a USB plug extends outward from the base;
in accordance with above structure, by the connection between the USB connector and a computer hub, the light bulb on the base illuminates and heats by 5-volt power supply from the computer hub so as to make the liquid inside the transparent container generate convective currents for driving the lustrous foil fragments and achieving dynamic visual effect.

2. The mini dynamic light as claimed in claim 1, wherein the USB connector having a wire and a USB plug; the wire is connected with the base.

3. The mini dynamic light as claimed in claim 1, wherein the USB connector having wire and two USB plugs; one of the USB plugs of the USB connector is connected with a USB socket of the base.

4. A mini dynamic light comprising a light set and a cigarette lighter plug set, wherein the light including a transparent container, a base, and a cover; the transparent container made of glass or heat-resistant plastic is disposed on top of the base with a low-boiling-point clear liquid as well as a plurality of differently colored lustrous foil fragments therein; a circuitry and a four or five watt light bulb are installed inside the base while the light bulb is close to bottom side of the transparent container for illuminating upwards;
the cigarette lighter plug set having a wire and a cigarette lighter plug extends outward from the base;
in accordance with above structure, by the connection between the cigarette lighter plug and a cigarette lighter socket, the light bulb on the base illuminates and heats by 12-volt power supply from car batteries so as to make the liquid inside the transparent container generate convective currents for driving the lustrous foil fragments and achieving dynamic visual effect.
